(19) United States
(12) Patent Application Publication
(10) Pub. No.: US 2006/0168032 A1
(43) Pub. Date: Jul. 27, 2006

(54) Unwanted message (spam) detection based on message content

(75) Inventors: Yigang Cai, Naperville, IL (US); Shehryar S. Qutub, Hoffman Estates, IL (US); Alok Sharma, Lisle, IL (US)

Correspondence Address: WERNER ULRICH, 434 MAPLE STREET, GLEN ELLYN, IL, 60137-3826, US

(73) Assignee: Lucent Technologies, Inc.

(21) Appl. No.: 11/018,270

(22) Filed: Dec. 21, 2004

(51) Int. Cl. G06F 15/16

(52) U.S. Cl. 709/206

(57) ABSTRACT

In a teleconmmunications network a method of detecting unwanted (spam) messages. The content of a suspected spam message is analyzed to determine if the weighted properties and weighted sums of properties of the message exceeds a threshold. If these weighted sums exceed a threshold, the message is treated as a spam message and is subject to human analysis to improve the quality of the weighting factors and the properties that are used in the analysis.

### RELATED APPLICATION(S)

This application is related to the applications of:

Yigang Cai, Shehryar S. Outub, and Alok Sharma entitled “Storing Anti-Spam Black Lists”;

Yigang Cai, Shehryar S. Qutub, and Alok Sharma entitled “Anti-Spam Server”;

Yigang Cai, Shehryar S. Qutub, and Alok Sharma entitled “Detection Of Unwanted Messages (Spam)”;

Yigang Cai, Shebryar S. Qutub, Gyan Shanker, and Alok Sharma entitled “Spam Checking For Internetwork Messages”;

Yigang Cai, Shebryar S. Qutub, and Alok Sharma entitled “Spam White List”; and

Yigang Cai, Shehryar S. Qutub, and Alok Sharma entitled “Anti-Spam Service”;

which applications are assigned to the assignee of the present application and are being filed on an even date herewith.

### TECHNICAL FIELD

This invention relates to methods for detecting spam messages based on the content of the message.

### BACKGROUND OF THE INVENTION

With the advent of the Internet, it has become easy to send messages to a large number of destinations at little or no cost to the sender. The messages include the short messages of short message service. These messages include unsolicited and unwanted messages (spam) which are a nuisance to the receiver of the message who has to clear the message and determine whether it is of any importance. Further, they are a nuisance to the carrier of the telecommunications network used for transmitting the message, not only because they present a customer relations problem with respect to irate customers who are flooded with spam, but also because these messages, for which there is usually little or no revenue, use network resources. An illustration of the seriousness of this problem is given by the following two statistics. In China in 2003, two trillion short message service (SMS) messages were sent over the Chinese telecommunications network; of these messages, an estimated three quarters were spam messages. The second statistics is that in the United States an estimated 85-90% of e-mail messages are spam.

A number of arrangements have been proposed and many implemented for cutting down on the number of delivered spam messages. Various arrangements have been proposed for analyzing messages prior to delivering them. According to one arrangement, if the calling party is not one of a pre-selected group specified by the called party, the message is blocked. Spam messages can also be intercepted by permitting a called party to specify that no messages destined for more than N destinations are to be delivered.

A called party can refuse to publicize his/her telephone number or e-mail address. In addition to the obvious disadvantages of not allowing callers to look up the telephone number or e-mail address of the called party, such arrangements are likely to be ineffective. An unlisted e-mail address can be detected by a sophisticated hacker from the IP network, for example, by monitoring message headers at a router. An unlisted called number simply invites the caller to send messages to all 10,000 telephone numbers of an office code; as mentioned above, this is very easy with present arrangements for sending messages to a plurality of destinations.

Among the more elusive spam messages are obnoxious messages for pornographic purposes or to carry unwanted advertisements to the receivers. Frequently, such messages can only be intercepted through an examination of the content of the message since the senders may be sending many innocuous messages from the same source. A major problem of spam detection is that of detecting spam based on the content of the message.

### SUMMARY OF THE INVENTION

The above problem is alleviated and an advance is made over the prior art in accordance with Applicants' invention wherein suspect messages are analyzed for the presence of certain properties such as key words and for the frequency of such properties; each property is given an appropriate spam index, a quantity that is almost static and is predefined and provisioned, and a weighting factor which changes dynamically, depends on traffic volume and message/content types. Messages are examined for any property whose frequency of use exceeds a threshold; predetermined combinations of properties whose combined use exceeds a threshold; and all properties whose combined use exceeds a threshold. In accordance with one feature of Applicants' invention, the weighting factor of each property can be dynamically adjusted to match the results of an examination of suspected messages by a human analyst. Advantageously, through the use of a human analyst the detection process can learn.

### BRIEF DESCRIPTION OF THE DRAWING(S)

FIG. 1 illustrates the operation of Applicants' invention; and

FIG. 2 is a flow diagram illustrating Applicants' invention.

### DETAILED DESCRIPTION

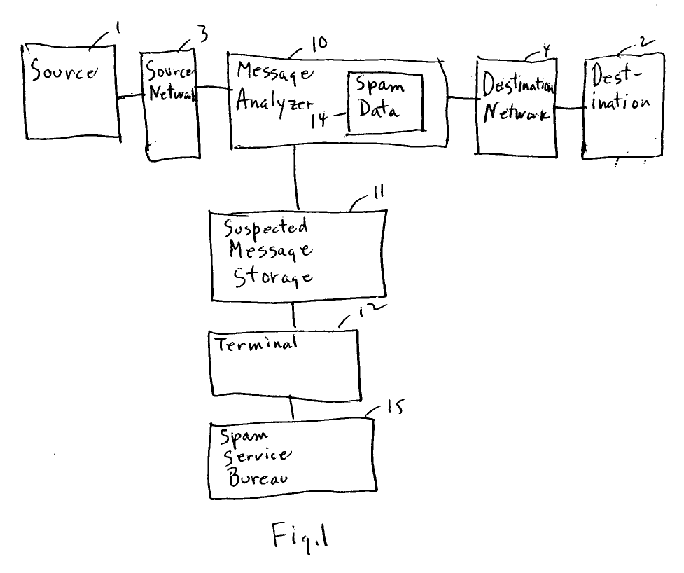

FIG. 1 illustrates the operation of Applicants' invention. A source 1 wishes to send a message to a destination 2. The message is sent to a network 3 which recognizes that this may be a spam message but one which requires message content analysis to make a determination. The network 3 passes the message to a message analyzer 10. If the message analyzer concludes that this is not a spam message, the message is sent via network 4 to destination 2.

The message analyzer 10 contains tabular data 14 of properties, severity index for each property, weighting factor for each severity index and severity level threshold for the property.

A spam property is a word, phrase, sentence, image or video segment that is a possible indicator of a spam message. The word “madam” is an example. For each property occurring in the message, a product of the number of occurrences of the property, the severity index and the weighting factor is calculated to derive a severity level. The severity levels are used to determine whether the message is to be treated as a spam message.

The severity index and severity threshold are kept relatively constant, but the weighting factor can be changed in response to messages from a spam service bureau 15, in response to detection at the bureau of special problem areas (to increase the weighting factor) or areas in which there has been little spam activity (to reduce the weighting factor).

The message analyzer takes the content of a message and looks for pre-stored properties such as, for example, the words “madam” and “lovers”. For each pre-stored property there is a weighting factor to indicate how heavily this property is to be weighted in arriving at a severity level. Messages whose severity level exceeds a predefined threshold are blocked and may be stored for further human analysis.

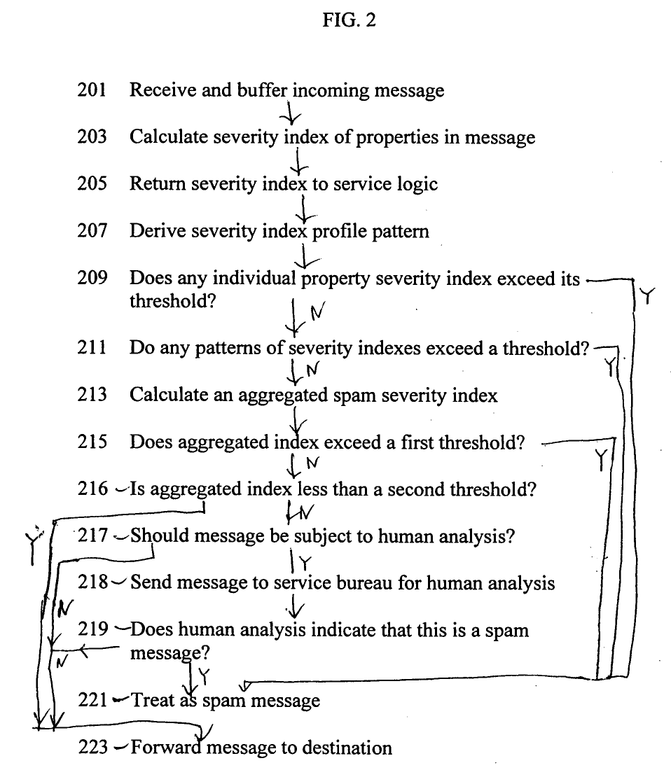

FIG. 2 is a flow diagram illustrating the operation of Applicants' spam check. An incoming message is received and buffered for spam analysis (action block 201). The spam tabular data is obtained in order to calculate spam severity index for properties of the message (action block 203). The spam analysis returns the spam severity index for message properties of the message (action block 205). Service logic fills in an analysis spreadsheet with severity index for each property and obtains the distributed spam severity index profile pattern (action block 207). Test 209 checks if any individual property severity index exceeds the threshold for that property. If any exceeds the limit (action block 221, to be described below) is entered. Otherwise, test 211 is entered to check whether any patterns of severity index exceed a threshold. If any exceed the threshold for the pattern, action block 221 is entered. Otherwise, an aggregated spam severity index is calculated using all the properties or all properties whose severity index exceeds a threshold (action block 213). If this aggregated index exceeds an upper threshold (test 215) the message is black. If it is less than a lower threshold (test 216) the message is white. For other messages, test 217 is used to determine whether the message should be subject to human analysis. If not, the message is relayed (action block 223) to its destination. If it has been selected for human analysis the message is sent to a service bureau (action block 218). The human examination result (test 219) will determine either a satisfactory result, and the message will be forwarded (action block 223), or an unsatisfactory result and the message will be treated as being spam and will be subject to the functions of action block 221.

Action block 221 stores the spam message, if necessary, stores an updated spam filter and rule service database that was derived by the human examination, and updates the spam severity weight factor and index upper limit and, if necessary, adds new distributed spam patterns.

The above description is of one preferred embodiment of Applicants' invention. Other embodiments will be apparent to those of ordinary skill in the art without departing from the scope of the invention. The invention is limited only by the attached claims.

We claim:

1. In a telecommunications network a method for detecting unwanted (spam) messages, comprising the steps of:
storing a weighting factor, an index, and a limit for each property of a potential message;
storing a suspected spam message;
deriving properties of the stored spam message;
calculating the product of the number of occurrences of each property, its weighting factor and its index;
forming a distributed spam profile from the products; and
determining whether said distributed spam profile meets the criteria for classifying a message as a spam message.

2. The method of claim 1 wherein if any product exceeds its upper limit for the property of that product, declaring the associated message a spam message.

3. The method of claim 1 further comprising the steps of:
storing for a plurality of patterns of properties an upper limit for each pattern; and
if the upper limit for any pattern is exceeded, declaring a message a spam message.

4. The method of claim 1 wherein if the sum of all products for said message exceeds a predetermined upper threshold, treating said message as a spam message.

5. The method of claim 1 wherein the weighting factor or upper limit of a property can be changed in response to a message from a service bureau.

6. The method of claim 1 wherein new properties can be added or old properties deleted in response to a message from a service bureau.

7. In a teleconmmunications network, apparatus for detecting unwanted (spam) messages, comprising:
means for storing a weighting factor, an index, and a limit for each property of a potential message;
means for storing a suspected spam message;
means for deriving properties of the stored spam message;
means for calculating the product of the number of occurrences of each property, its weighting factor and its index;
means for forming a distributed spam profile from the products; and
means for determining whether said distributed spam profile meets the criteria for classifying a message as a spam message.

8. The apparatus of claim 7 wherein if any product exceeds its upper limit for the property of that product, means for treating the associated message as a spam message.

9. The apparatus of claim 7 further comprising:
means for storing for a plurality of patterns of properties an upper limit for each pattern; and
if the upper limit for any pattern is exceeded, means for treating a message as a spam message.

10. The apparatus of claim 7 wherein if the sum of all products for said message exceeds a predetermined upper threshold, means for treating said message as a spam message.

11. The apparatus of claim 7 further comprising means for changing the weighting factor or upper limit of a property in response to a message from a service bureau.

12. The apparatus of claim 7 further comprising means for adding new properties or deleting old properties in response to a message from a service bureau.
